(19) United States
(12) Patent Application Publication
(10) Pub. No.: US 2017/0247862 A1
(43) Pub. Date: Aug. 31, 2017

(54) ATMOSPHERIC WATER GENERATION SYSTEMS AND METHOD OF OPERATING THE SAME

(71) Applicant: SEAS SOCIÉTÉ DE L'EAU AÉRIENNE SUISSE SA, Lugano (CH)

(72) Inventor: Flavio GIACOMINI, Borgomanero (NO) (IT)

(73) Assignee: SEAS SOCIÉTÉ DE L'EAU AÉRIENNE SUISSE SA, Lugano (CH)

(21) Appl. No.: 15/505,290

(22) PCT Filed: Sep. 12, 2014
(86) PCT No.: PCT/IB2014/001813

§ 371 Date: Feb. 21, 2017

(51) Int. Cl. E03B 3/28; B01D 5/00

(52) U.S. Cl. CPC E03B 3/28; B01D 5/0003; B01D 5/0051

(57) ABSTRACT

An atmospheric water generation system (20) comprising a casing (22); a water condensing heat exchanger (62) located in the casing to receive ambient air from an air inlet (42); a chiller unit (80) located in the casing to provide the water condensing heat exchanger (62) with a chilled coolant; and an electronic control system (500) configured to: monitor one or more characteristic parameters of the ambient air outside and nearby the casing (22), and start the water generation on the basis of the monitored value (AT, AH, AP) of said one or more air characteristic parameters.

### FIELD OF THE INVENTION

The present invention relates to the field of atmospheric water generation systems and more particularly to integrated air conditioning and atmospheric water generation systems that condense water from air to provide drinking water.

### BACKGROUND OF THE INVENTION

Potable drinking water is a shrinking resource around the world. It is in short supply in many parts of the world, and in the future it will become more even challenging to supply the water requirements of growing populations. Climate change effects have begun to alter expected weather and water patterns, and these changes, combined with an ever-increasing human population and increased water requirements for domestic, agriculture and industrial sectors has led and will lead to shortages.

The problem is particularly acute in places such as tropical islands, and floating installations such as oil rigs, and at remote or tropical locations that lack a water supply infrastructure. For example, on many islands, consumers must purchase expensive bottled water, or refill water jugs with water of questionable purity at local water stations. There are no wells, most houses are not on city water and even if they are, the city water is not potable. Many homes use rain water runoff guttered into a cistern sanitized with bleach.

In other locations lacking a water piping infrastructure, such as in the Middle East, the typical water source is delivered “jug water,” obtained from local water sources. Such water is often of questionable purity and flavor.

The problem is also found in places where the existing water infrastructure has not been maintained. Water pipes may leak, cisterns may be cracked, such that the quantity of available water is less than amounts available a century ago. In addition, such systems also are at risk for contamination of the water supply from such leaks and from other causes.

Ambient air typically contains moisture. The amount of water in ambient atmospheric air varies with temperature and pressure. Hot humid air contains more water than cold dry air. Moisture contained in ambient air condenses into liquid form as droplets when the air temperature drops below a determined dew point.

Many atmospheric water generating machines have been proposed in the past. The typical machine has a cooling element that receives filtered ambient air and cools the air to condense moisture. The condensation is collected, sterilized by UV light and/or ozone, and stored and/or dispensed. The temperature of the cooling element is maintained so that is does not reach the freezing point which would decrease water collection efficiency. However, such systems, whether large or small, have been dependent on an electrical system infrastructure to operate the systems. Small, water cooler size systems, while portable, have insufficient capacity to supply the needs of a substantial population. Larger installations are all custom built and are not designed to be readily deployed using standard commercial transport systems.

Last but not least the water production cost using atmospheric water generating machines of the prior art is very high and not cost-effective. One of the reasons of this side effect lies in that many atmospheric water generating machines operate under low efficiency conditions.

The efficiency of water generating machines depends not only on constructional aspects but it is also heavily affected by the weather conditions in which each individual machine operates. As already mentioned, one of the most relevant weather conditions is represented by the moisture content of the ambient air, which depends on the relative humidity of the air in connection with air temperature and air pressure. In order to generate a predetermined target quantity of water, if the moisture content in the ambient air is small, an atmospheric water generating machine will generally consume a quantity of energy (e.g. electrical energy and/or fuel) which is bigger than the quantity of energy that the same machine would consume, if the moisture content in the ambient air were larger.

As a consequence, once the atmospheric water generating machine has been placed in its final location, there may be periods when the weather conditions are favourable to the water generation, and other periods when unfavourable weather conditions make advisable to stop the water generation and save energy.

The atmospheric water generation machines of the prior art are generally operated only through an electric switchboard mounted on the machine, and by human operators who manually activate specific start and/or stop switches on said switchboard. In order to limit the power consumption of these machines, it is thus necessary to have technical experts working on site, who are able to decide whether to start or stop the machine on the basis of the actual weather conditions.

However, the recruitment of technical experts may be neither simple nor cost-effective, especially if the atmospheric water generation machine is installed in remote or desert regions.

### SUMMARY OF THE INVENTION

In view of the above, an object of an embodiment of the present invention is that of solving or at least positively reducing the above mentioned drawbacks. Another object is that of reaching this goal with a simple and rational solution.

These and other objects are achieved by the embodiments of the invention as defined herein.

In accordance with one embodiment of the invention an atmospheric water generation system comprises:
a casing;
a water condensing heat exchanger located in the casing to receive ambient air from an air inlet;
a chiller unit located in the casing to provide the water condensing heat exchanger with a chilled coolant; and
an electronic control system configured to:
   monitor one or more characteristic parameters of the ambient air outside and nearby the casing, and
   start the water generation on the basis of the monitored value of said one or more air characteristic parameters.

Thanks to this solution, the atmospheric water generation system may be started automatically, without the need of any operator or technical expert working on site, but simply relying on the current conditions of the ambient atmospheric air that is going to be treated.

According to an aspect of the invention, the electronic control system may be also configured to stop the water generation on the basis of the monitored value of said one or more characteristic parameters.

In this way, the atmospheric water generation system may be also stopped automatically, without the need of any operator or technical expert working on site.

According to another aspect of the invention, said one or more air characteristic parameters may be chosen in the group consisting of: air temperature, air humidity and air pressure.

These parameters have a relevant impact on the performance of the atmospheric water generation system, therefore they are reliable criteria on which the decision to start and/or stop the system may be based.

According to a more specific aspect of the invention, the electronic control system may be configured to:
use the monitored value of said one or more air characteristic parameters to estimate a value of an index representative of a water generation capability of the atmospheric water generation system, and
start the water generation, if the estimated value of the water generation capability index is above a predetermined threshold value thereof.

Thanks to this solution, the water generation is started only if, under the current ambient air conditions, the atmospheric water generation system is actually able to guarantee the generation of a desired quantity of water. In particular, the threshold value of the water generation capability index may represent a minimum value of the generated water, below which the operational efficiency of the atmospheric water generation system is considered too low.

According to an aspect of the invention, the electronic control system may be configured to estimate the water generation capability index as a water quantity that is generated per unit time, for example expressed in liters per hour or liters per day.

This aspect of the invention has the effect of subordinating the starting of the water generation to the water flow rate actually producible by the atmospheric water generation system.

According to another aspect of the invention, the electronic control system may be configured to:
estimate a value of a water quantity that is generated per unit time,
estimate a value of a fuel quantity that is consumed by an electric generator per unit time to operate the atmospheric water generation system during the water generation,
calculate the water generation capability index as a ratio of the water quantity value to the fuel quantity value.

This aspect of the invention has the effect of taking into account also the fuel consumption, thereby providing a water generation capability index which is a direct measure of the efficiency of the atmospheric water generation system. Hence, this aspect of the invention allows to start the water generation only when the atmospheric water generation system is expected to operate under good efficiency conditions, thereby achieving a relevant optimization of the process.

According to another aspect of the invention, the electronic control system may be configured to determine the threshold value of the water generation capability index on the basis of a geographical location of the atmospheric water generation system.

This aspect of the invention in useful because there may be locations where the average ambient air conditions (e.g. over a season or a year) are less favourable for the water generation than in other locations. This aspect of the invention has the thus effect of taking into account this fact and of adapting the operation of the atmospheric water generation system to the specific climate context.

According to another aspect of the invention, the electronic control system may be configured to stop the water generation, if the estimated value of the water generation capability index is below said threshold value.

Thank to this solution it is possible to automatically interrupt the operation of the atmospheric water generation system, when the ambient air conditions are no longer favourable for the water generation.

According to a more specific aspect of the invention, the electronic control system may be configured to stop the water generation, if the estimated value of the water generation capability index remains below said threshold value for a predetermined time period.

In this way, the operation of the atmospheric water generation system is not interrupted immediately, but only if the ambient air conditions remain unfavourable for a prolonged time, thereby preventing incidental stop due to transitory changes of the ambient air conditions.

According to an aspect of the invention, the electronic control system may be configured to measure the values of said one or more air characteristic parameters through one or more sensors, for example through the sensors of a weather station.

This solution provides a reliable solution for monitoring said parameters in real time.

According to another aspect of the invention, the electronic control system may be configured to receive the values of said one or more air characteristic parameters from a weather forecasting center.

This aspect of the invention allows to reduce the cost of the atmospheric water generation system.

According to still another aspect of the invention, the electronic control system may comprise a control unit configured to send data and receive commands to/from a remote administration unit.

Thanks to this solution the operation of the atmospheric water generation system may be monitored and controlled from a remote location, without the need of human operators on site.

According to an aspect of the invention, the control unit may be connected to the remote administration unit by means of a remote data transmission system.

In this way the administration system may be located far removed from the location of the atmospheric water generation system, even in another country or continent.

According to an aspect of the invention, the remote data transmission system may be based on internet.

This aspect of the invention allows a simple and cost effective data/command transmission.

According to another aspect of the invention, the electronic control system may be further configured to:
monitor a water quantity in a water collecting container provided for receiving water from the water condensing heat exchanger,
activate a pump to deliver the water from the collecting container into a storage tank, if the monitored value of the water quantity in the collecting container is above a predetermined threshold value thereof.

Thanks to this solution, the condensed water may be delivered into the storage tank, thereby emptying (or almost emptying) the water collecting container and making it ready to receive other water.

According to another aspect of the invention, the electronic control system is configured to deactivate the pump, if the monitored value of the water quantity in the collecting container is below a predetermined second threshold value thereof, wherein the second threshold value is smaller than the first threshold value.

This aspect of the invention allows to periodically deliver the condensed water from the water collecting container to the storage tank, without the need of a continuous monitoring of the pump operation.

According to another aspect of the invention, the electronic control system may be configured to:
monitor a water quantity in the storage tank,
stop the water generation, if the monitored value of the water quantity in the storage tank exceeds a predetermined threshold value thereof.
   This solution allows to automatically stop the atmospheric water generation system, once its overall water storage capacity has been completely exploited.
   Another embodiment of the invention provides a method of operating an atmospheric water generation system,
   wherein the atmospheric water generation system comprises:
a casing;
a water condensing heat exchanger located in the casing to receive ambient air from an air inlet; and
a chiller unit located in the casing to provide the water condensing heat exchanger with a chilled coolant; and
   wherein the operating method comprises the steps of:
monitoring one or more characteristic parameters of the ambient air outside and nearby the casing, and
starting the water generation on the basis of the monitored value of said one or more air characteristic parameters.

This embodiment achieves basically the same effects of the electronic control system disclosed above, in particular that of automatically staring the atmospheric water generation system without the need of any operator or technical expert working on site

All the additional operations that may be performed by the electronic control system according to the various aspects of the invention disclosed above, may be considered as correspondent procedural steps of the operating method according to correspondent aspects of this second embodiment of the invention.

### BRIEF DESCRIPTION OF THE DRAWINGS

FIG. 1 is a side and top perspective view of an embodiment of an atmospheric water generation system in accordance with the invention with its side and top exterior walls removed to display the internal components thereof.

FIG. 2 is a front, side and top perspective view of the atmospheric water generation system of FIG. 1 with its side and top exterior walls removed to display the internal components thereof showing air circulation through the air treatment unit.

FIG. 3 is a top plan view of the atmospheric water generation system of FIG. 1 with its top exterior wall removed to display the internal components thereof.

FIG. 4 is a side elevation schematic view of the atmospheric water generation system of FIG. 1 showing alternative options for the location of the water treatment unit and generator system.

FIG. 5 is a side elevation schematic view of an air treatment unit of an atmospheric water generation system in accordance with the invention.

FIG. 6 is a top plan schematic view of the air treatment unit of an atmospheric water generation system of FIG. 5.

FIG. 7 is a side elevation schematic view of an embodiment of a water treatment unit of an atmospheric water generation system in accordance with the invention.

FIG. 8 is a front, side and top perspective view of the atmospheric water generation system of FIG. 1 having all its side walls and showing openable louvers and hatches provided in the end walls, sidewalls and roof thereof.

FIG. 9 is a scheme that represents an electronic monitor and control system of an atmospheric water generation system in accordance with the invention.

FIG. 10 is a flowchart of an efficiency estimation procedure used for automatically starting and stopping an atmospheric water generation system in accordance with the invention.

FIG. 11 is a flowchart of a method of starting an atmospheric water generation system in accordance with the invention.

FIG. 12 is a flowchart of a method of stopping an atmospheric water generation system in accordance with the invention.

FIG. 13 is a flowchart of a method of controlling the operation of a pump in a water treatment unit of an atmospheric water generation system in accordance with the invention.

FIG. 14 is a flowchart of another method of stopping an atmospheric water generation system in accordance with the invention.

### DETAILED DESCRIPTION OF THE INVENTION

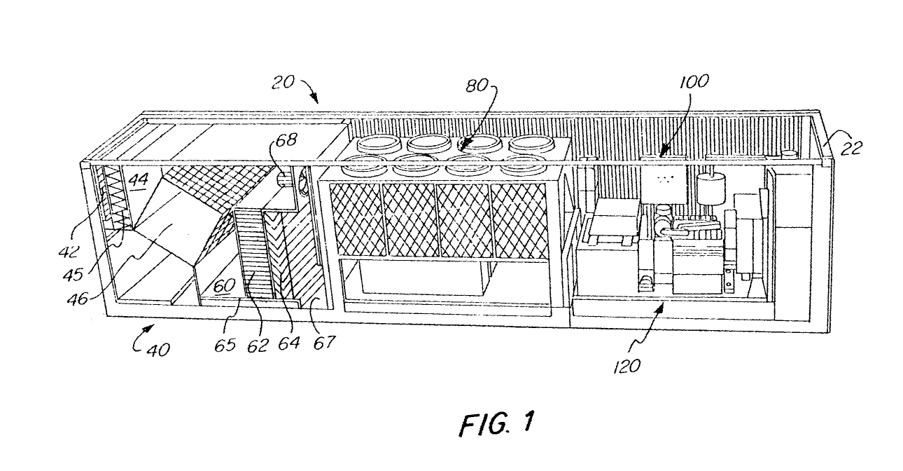

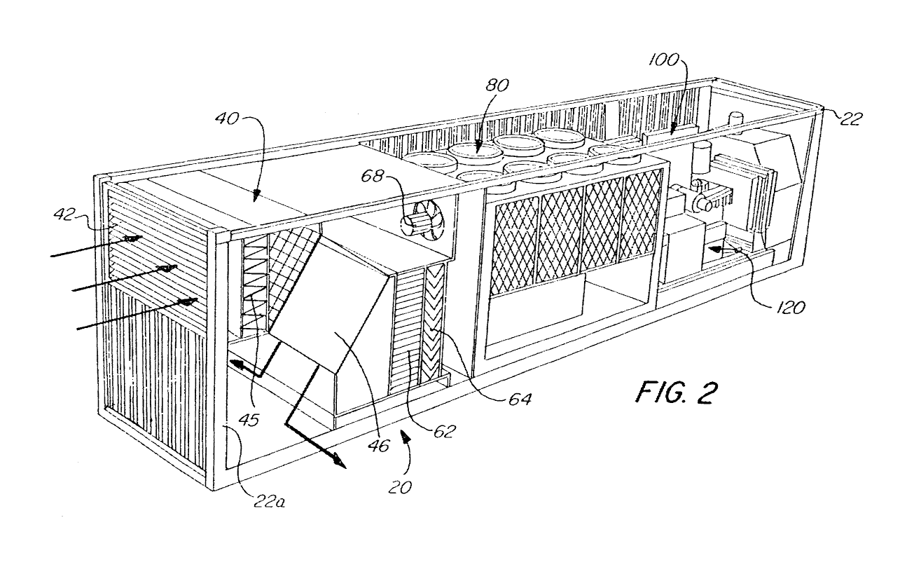

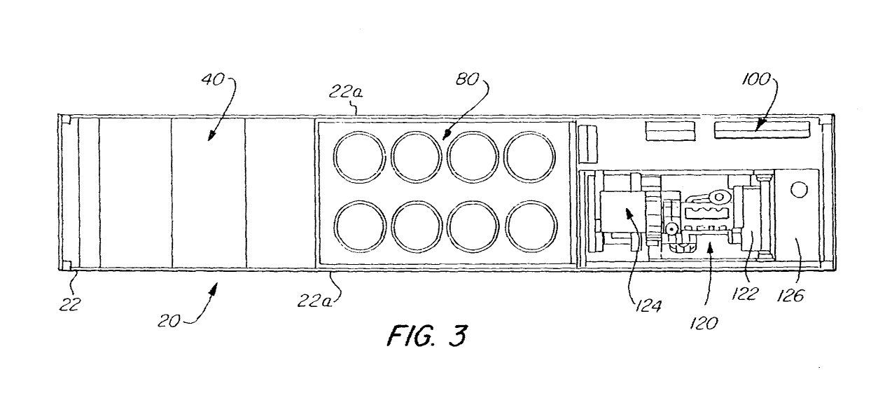

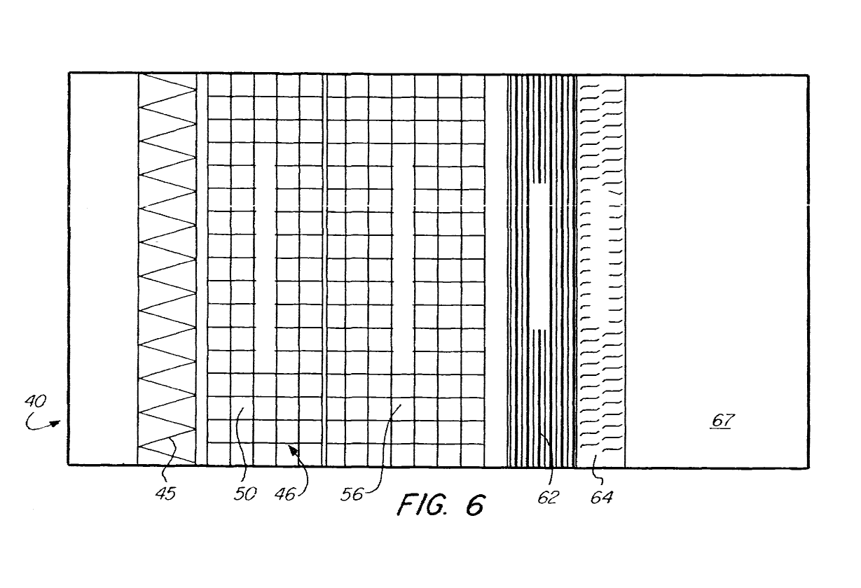

Referring now to FIGS. 1-8, where like numerals indicate the same elements in the Figures, an atmospheric water generation system 20 is shown. Atmospheric water generation system 20 is capable of generating 10.1 m³/day of pure water under optimum atmospheric conditions.

Atmospheric water generation system 20 includes an air treatment unit 40 associated with a chiller unit 80, a water treatment unit 100, and a generator system 120.

According to the illustrated embodiment of the invention the atmospheric water generation system 20 is a high performance integrated water production machine which is assembled into a casing having a standard shipping container size, specifically a container 22 which is the size of a ISO standard 40′ high-cube container (length 12.19 m×width 2.44 m×height 2.90 m) (40′×8′×9′6″). According to different embodiment of the invention larger casing may also be used including a 45′ high cube container size, but in most cases the 40′ high-cube container size is easily transportable and is sufficient for the invention.

Casing 22 is seen in FIGS. 1-6, and contains the air treatment unit 40, the chiller unit 80, the water treatment unit 100, and the generator system 120. In general, the component elements of atmospheric water generation system 20 are each sized to occupy approximately one-third of the casing 22. The three main component elements—the air treatment unit 40, the chiller unit 80, and the generator system 120; are designed as modular components having a length of about 4 meters. In most configurations, the water treatment unit 100 will be co-located with the generator system 120.

According to this embodiment of the invention the air treatment unit 40, as seen in FIGS. 1-6, has an inlet 42 for receiving an incoming stream of ambient air, and an inlet chamber 44 extending from the inlet 42. An air filter system 45 is preferably directly associated to the inlet air. In detail the air filter system 45 is provided in the inlet air chamber 44. Air filter system 45 operates to remove insects, windblown debris, dirt, sand and other contaminants from the incoming air stream. The air filter system 45 may comprise any type of filter known in the art for air filtration, and may be a flat filter, pleated filter, pocket filter, rigid cell filters. The filter media may be selected from glass fibers or synthetic fibers. In one embodiment, the filters are selected and sized to accommodate a design airflow in heavy duty (dusty) conditions.

Inlet air chamber 44 connects to a crossflow air to air heat exchanger 46 having a first heat exchange area 48 and a second heat exchange area 54. The first heat exchange area 48 has a first inlet 50 receiving air from the inlet chamber 44 and a first exit 52 for discharging air. The second heat exchange area 54 has a second inlet 56 and a second exit 58. Cross flow heat exchanger 46 is preferably a high performance, low weight aluminum heat exchanger with non-fouling corrugated surfaces and a single pass efficiency of 50-70%. Epoxy coated plates may be selected as an option for use in coastal environments.

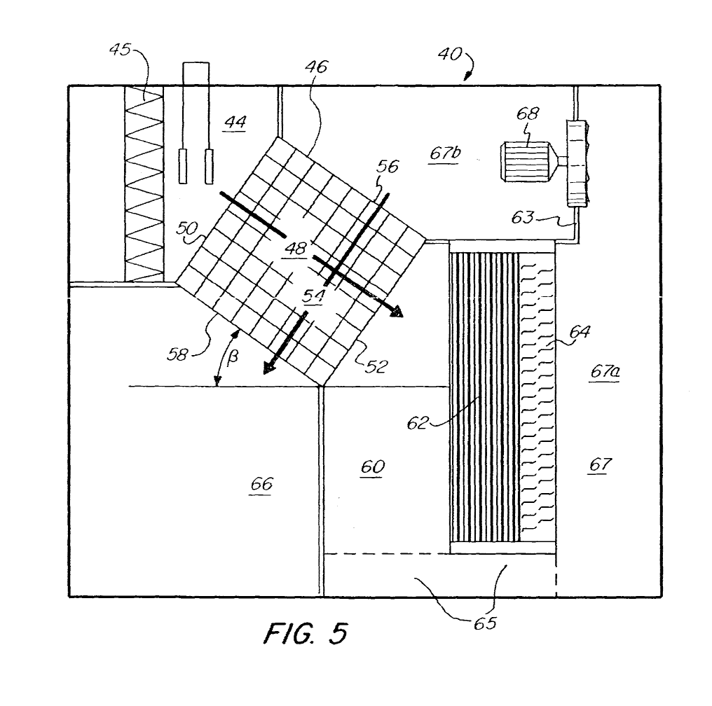

Crossflow heat exchanger 46 is generally a rectangular solid positioned at an angle such that the heat exchanger as viewed from the side appears to be inclined with respect to a horizontal plane A (FIG. 5). According to the invention the angle β of inclination of the crossflow heat exchanger 46, with respect to the horizontal plane, is comprised in a range between 30 and 60 degrees. Preferably the angle β of inclination is preferably 45 degrees. The uniquely positioned angled crossflow heat exchanger allows the air treatment unit 40 to have a substantially reduced size while still obtaining the desired efficiency. Therefore this configuration concurs to minimize the overall size of the casing, facilitating the transportation of the atmospheric water generation system 20.

As described hereafter, the crossflow heat exchanger 46 operates to precool the incoming air stream before the air reaches the water condensing heat exchanger 62 where water is condensed from the air and collected.

This solution allows to increase the performance of the atmospheric water generation system 20 and the productivity of water quantity, for a given amount of supplied energy, up to 40%.

A condensation chamber 60 extends from the crossflow heat exchanger first exit 52. The water condensing tube and plate heat exchanger 62 is located in the condensation chamber 60. Surfaces of the water condensing heat exchanger 62 are chilled to below the dew point, and accordingly water vapor in the air stream condenses out of the air stream and onto the plates and other surfaces of the water condensing heat exchanger 62. A drop separator 64 (mist eliminator) is located downstream of and adjacent to the water condensing heat exchanger 62 and collects entrained water droplets from the air stream.

A water collecting container 65 is a tray or bin and is located below the water condensing heat exchanger 62 and the drop separator 64 so that condensed water that is collected on the chilled surfaces of the water condensing heat exchanger 62, and which runs down the walls of the water condensing heat exchanger 62 by gravity, is collected and pumped to the water treatment unit 100 by means of a pump 101.

An air recirculation chamber 67 extends from the water condensing heat exchanger 62 to the second inlet 56 of the crossflow heat exchanger 46. Air that has passed through the crossflow heat exchanger 46 and been precooled, and which has then been significantly further cooled by passage through the water condensing heat exchanger 62, is thus returned to the crossflow heat exchanger 46 to provide cooling to the incoming air stream. Air recirculation chamber 67 may be comprised of two or more subchambers 67a and 67b such as illustrated in FIG. 5 with connecting openings between the various subchambers.

Cooled demoisturized air exits the crossflow heat exchanger 46 from the second exit 58 of the crossflow heat exchanger 46 into an outlet chamber 66. Outlet chamber 66 exhausts the cooled, demoisturized air to an air outlet 70. In the preferred embodiment, air outlet 70 comprises two laterally located exhaust vents 70a on sides 22a of the casing 22, but the air outlet 70 may be located elsewhere, such as in an end wall of casing 22, as desired.

According to a different embodiment of the invention air outlet 70 will preferably be connected by ducting to a building, tent or other structure where cooled air is desired.

An air blower 68 is preferably located in air recirculation chamber 67 between subchambers 67a and 67b. Air blower 68 may be any type of energy efficient blower system known in the art and may include centrifugal fans and axial fans. Although a single appropriately sized blower may be used, to better fit the blower units in the casing 22, there are preferably two smaller blower units 68 provided side-by side in wall 63 between subchambers 67a and 67b. Alternatively, air blower 68 may be located in the outlet chamber 66, or any of the other chambers 44, and 60.

The above described components of the air treatment unit 40, disclosed in this embodiment of the invention, are sized to process at least 30,000 m³/hour airflow, and preferably are sized to process between 30,000 m³/hour and 40,000 m³/hour airflow.

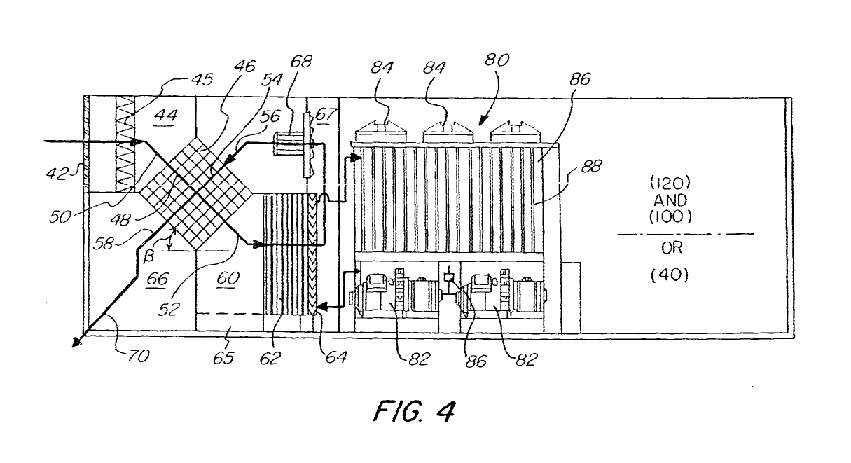

A chiller unit 80 is also located in the casing. Chiller unit 80 may be based on any of a number of known cooling technologies, however, in most applications a conventional vapor compression refrigeration cycle will be the most robust and versatile system. Thus, the chiller unit 80, as shown in FIG. 4, is a refrigeration system comprising a coolant fluid circulating through a compressor 82, a condenser 84, an expansion valve (not shown), and an evaporator 88.

Compressor 82 is preferably a semi-hermetic single screw compressor. The coolant is preferably R-134a coolant. The condenser 84 is a tube and fin condenser. The expansion valve 86 is an electronic expansion valve. The evaporator 88 is a single pass direct expansion shell and tube evaporator. The evaporator stage of the chiller unit 80 is contained in the chiller unit 80. The evaporator stage chills a water/glycol coolant mixture which is circulated by a circulator pump to the water condensing heat exchanger 62. The water condensing heat exchanger 62 contains channels through which the water/glycol coolant mixture is circulated, chilling the surfaces of the water condensing heat exchanger 62 to condense water thereon. Cooling is thus delivered to the water condensing heat exchanger 62 to maximize water production.

Desirably chiller unit 80 has a cooling power range of between 50 and 400 kW. It is preferable that the chiller unit 80 be able to deliver cooling power of 400 kW in to permit operation of the unit in a wide range of atmospheric conditions.

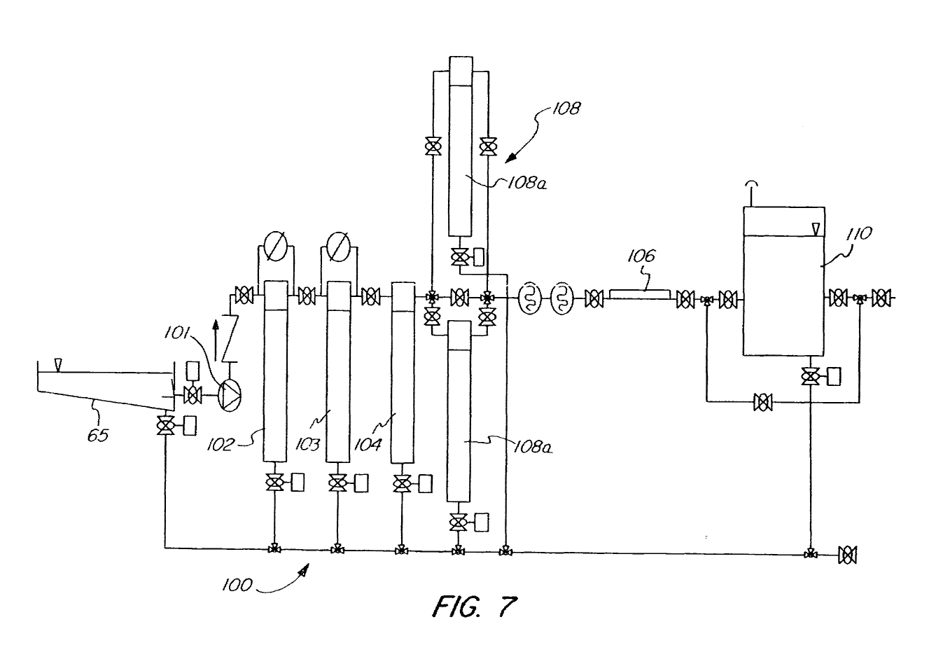

A water treatment unit is also provided in the casing 22. Water treatment unit 100 is illustrated in FIG. 7. The water treatment unit 100, is connected to the water collecting container 65 by means of the pump 101 and includes one or more of, and preferably all of: particulate filters 102 and 103; an activated charcoal filter 104; and an ultraviolet light sterilizing chamber 106. Particulate filter 102 is a 50 μm (micron) filter; particulate filter 103 is a 5 μm (micron) filter. The activated charcoal filter 104 has a porosity of 5 μm. The particulate filters 102, 103 and the activated charcoal filter 104 are preferably cartridge filters. Ultraviolet light sterilizing chamber 106 comprises an ultraviolet lamp capable of irradiating water at a wavelength between 245 nm and 285 nm, preferably including 254 nm, at a sufficient dose and for a sufficient time period to sterilize microorganisms in the produced water. An alternative sterilization system such as an ozone injection system may be used. Particulate filters 102 and 103, and the activated charcoal filter 104 are connected in series.

The water treatment unit 100, comprises also a calcite media mineralization system 108 to add mineral salts or other additives to collected water to improve flavor, prevent bacteria, and provide essential dietary minerals to the collected water.

The mineralization system 108 is connected in series to the activated charcoal filter 104 and comprises two mineralization units 108a connected in parallel between them and fluidly connected to the ultraviolet sterilizing chamber 106.

The purified water is then delivered to a storage tank 110. Storage tank 110 is desirably a 100 liter tank sized to hold collected water. Storage tank 110 is provided with an appropriate outlet valve system, so that collected water in storage tank 110 may be dispensed into jugs, water trucks, or to a local sanitary water distribution piping system.

The air treatment unit 40 and the water treatment unit 100 are sized to accommodate water production flow of up to 10.1 m³/day.

A generator system 120 may be also located in or on the casing 22. The generator system 120 generates electrical power to operate the air treatment unit 40, chiller unit 80, and water treatment unit 100. The generator system 120 may comprise: an internal combustion engine generator, or a hydrogen fuel cell; or a solar panel system.

In FIGS. 1-3, generator system 120 is a self-contained diesel engine 122 and generator 124. Diesel engine 122 and generator 124 desirably have a capacity of at least 250 kW, with an optional range of up to 400 kW. The diesel engine includes a 120 liter fuel tank 126, and heavy duty air and oil filter systems. The generator 124 is a synchronous three phase alternator.

Preferably, the water treatment unit 100 and the generator system 120 are co-located adjacent each other within the same section of the casing. In other embodiments, the water treatment unit 100 and the chiller unit 80 are co-located adjacent each other within the same section of the casing.

The three main component elements—the air treatment unit 40, the water treatment unit 100 with the chiller unit 80; and the generator system 120; are designed as modular components. Each modular component has a length of about 4 meters. The modular design of the present invention provides a great deal of flexibility. The above noted three main component elements can be placed in casing 22 in various combinations as needed. This permits a convenient modular approach to fabricating each atmospheric water generation system 20.

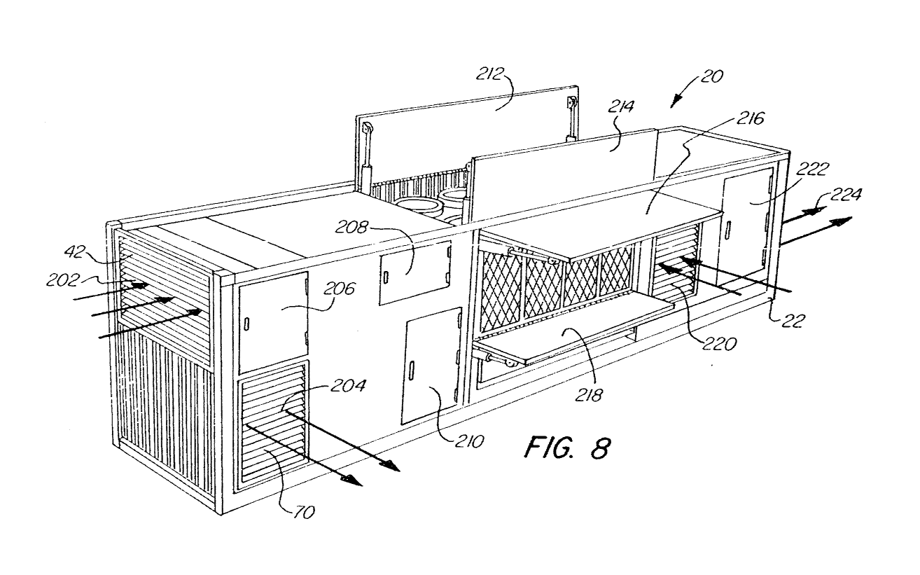

The casing 22 containing the atmospheric water generation system 20 is provided with openings for inlet and exhaust air to the air treatment unit 40, the chiller unit 80 and the diesel engine of generator system 120. Hatches covering the chiller unit 80 can be opened to permit air flow through chiller unit 80. Appropriate doors and hatches allow access to the various components. These louvers, doors, and hatches can be closed when the system 20 is transported or when dust storms or other bad weather events occur to protect the system components. They can then be opened when the system is operated. In a preferred embodiment, illustrated in FIG. 8, air treatment unit 40 has a powered adjustable louvered shutter 202 at air inlet 42, and a powered adjustable louvered shutter 204 at air outlet 70, that automatically opens when the system is operated. Manual hatch doors 206, 208, and 210 allow access to various parts of the air treatment unit 40. In this preferred embodiment, the chiller unit 80 has powered upper hatch doors 212 and 214, and lateral hatch doors 218 and 216 on both sides of casing 22 that automatically open when the system is operated. Generator system 120 also has powered adjustable louvered shutters 220 and 224 at the air inlet and outlet for the diesel engine. A manual hatch door 222 provides access to the generator system 120.

The atmospheric water generation system 20 has a potable water production capacity which is greater than or equal to about 10 cubic meters a day at reference conditions (T=30° C. and Relative Humidity=70%). It is easily transported using existing intermodal transport systems. It can be supplied in a self contained system that can be delivered to disaster sites such as areas devastated by floods, tsunamis, or other disasters which disrupt water supplies. It can be transported to tropical locations such as islands and to remote areas in need of water.

An important feature of the present invention is that it provides for concurrent generation of both water and cooled air. This dual functionality permits the atmospheric water generation system of the present invention to be economically viable by providing two significant and desirable output flows.

The present invention is therefore a new and nonobvious invention that can assist in providing clean water resources to the parts of the world where water is badly needed.

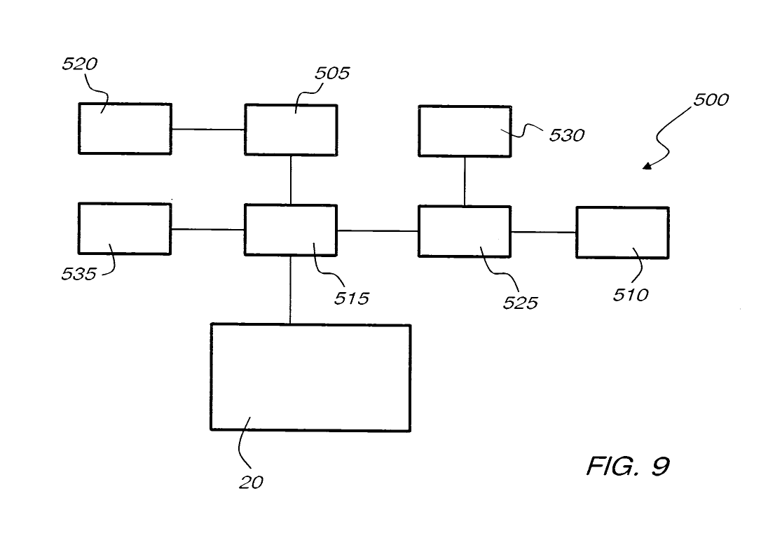

The operation of the atmospheric water generation system 20 is controlled by an appropriate electronic monitor and control system 500, as schematically represented in FIG. 9, which coordinates the operation of the system components and collects and acts on data provided by sensors in the system.

The electronic monitor and control system 500 is in charge of automation of the atmospheric water generation system 20 and provides an interface through which it's possible to start/stop the system, configure the system and check the status of operation. These control and monitoring operations may take place either locally, in the case where an operator is to execute them in direct contact with the atmospheric water generation system 20, or remotely, through a central control station geographically far from the atmospheric water generation system 20, for example located in another nation or another continent.

The electronic monitor and control system 500 is comprised of two main parts: a control unit 505 located aboard the atmospheric water generation system 20, for example located inside the casing 22, and a remote administration unit 510 located in the central control station. Both the control unit 505 and the remote administration unit 510 are composed from hardware and software.

The control unit 505 is connected to a number of sensors and to other parts of the electronic control and monitor system 500 through a data acquisition module 515 and appropriate connections. For reasons of reliability and safety, a redundancy electronic module 520 joins the control unit 505 and replaces it in case of malfunctions. Both the data acquisition module 515 and the redundancy module 520 may be disposed aboard the atmospheric water generation system 20, for example located inside the casing 22.

The control unit 505 may include at least a digital central processing unit (CPU) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. In this way, the control unit 505 is connected to all the subsystems that make up the atmospheric water generation system 20, in order to send the commands necessary for the proper operation and to the acquisition of the state. The program may thus embody the methods disclosed herein, allowing the CPU to carryout out the steps of such methods and control the atmospheric water generation system 20. The control unit 505 may also include a human interface device, such as a touchscreen display, through which an operator can start/stop the atmospheric water generation system 20, configure the system and check the status of operation.

In particular, the control unit 505 may be embodied as an industrial computer, which implements the logic of the system and provides, through the touch screen display, the main interface to the atmospheric water generation system 20. Industrial computers are particularly resistant to such factors as vibration, electro-magnetic interference, operating temperatures. Moreover, industrial computers have a great flexibility in programming and are relatively cheap. In other embodiments, the control unit 505 may be embodied as a PLC (Programmable Logic Controller), which may be composed of modules of input/output analog-to-digital and a calculation module, which is programmed to implement the operating logic of the system.

The redundancy module 520 may be a microprocessor based electronic control unit, disposed aboard the atmospheric water generation system 20 and connected to the control unit 505. The redundancy module 520 is configured to implement the basic functionality of control and communication for the atmospheric water generation system 20, in the event of a malfunction of the control unit 505. The redundancy module 520 brings and keeps the atmospheric water generation system 20 in a state of safe and stable operation until the control unit 505 is replaced.

The control unit 505 communicates with the remote administration unit 510 via a remote data transmission system 525 which may include a geolocalization module 530. The remote data transmission system 525 may allow communication between the control unit 505 and the remote administration unit 510 via Ethernet cable, GPRS network (standard mobile network), satellite network or other technologies. Regardless of the communication technology used, the connection from the on-board control unit 505 and the remote administration unit 510 may occur towards the Internet network using for example the TCP/IP or UDP/IP according to the need. The communication may take place in encrypted to prevent unwanted access to the communication channel. The encryption level may depend on the type of communication channel adopted, since encryption has impact on the amount of data to transmit. The geolocation system 530 may be based on the GPS technology and may be used to verify the movements and the actual geographical location of the atmospheric water generation system 20. The location data may be sent to the remote administration unit 510, where they may be consulted at any time.

The monitor and control system further comprises a weather station 535, which may be installed aboard the atmospheric water generation system 20, for example placed in or on the casing 22. The weather station 535 generally includes a number of sensors and equipment for measuring atmospheric conditions outside and nearby the casing 22, to provide information for operating the atmospheric water generation system 20. The measurements taken by the weather station 535 include some air characteristic parameters, such as air temperature, barometric air pressure and air humidity (e.g. relative humidity). Hence, the weather station 535 may generally include a thermometer for measuring air temperature, a barometer for measuring atmospheric pressure and an hygrometer for measuring humidity. The data provided by the weather station 535 may be sent to the control unit 505 via the data acquisition module 515, and to the remote administration unit 510 via the remote data transmission system 525. In other embodiments, the measurements of said air characteristic parameters (e.g. air temperature, air pressure, air humidity, etc.) may be provided by a remote weather forecasting center (not shown), which may be connected to the control unit 505 and/or to the remote administration unit 510 through the remote data transmission system 525.

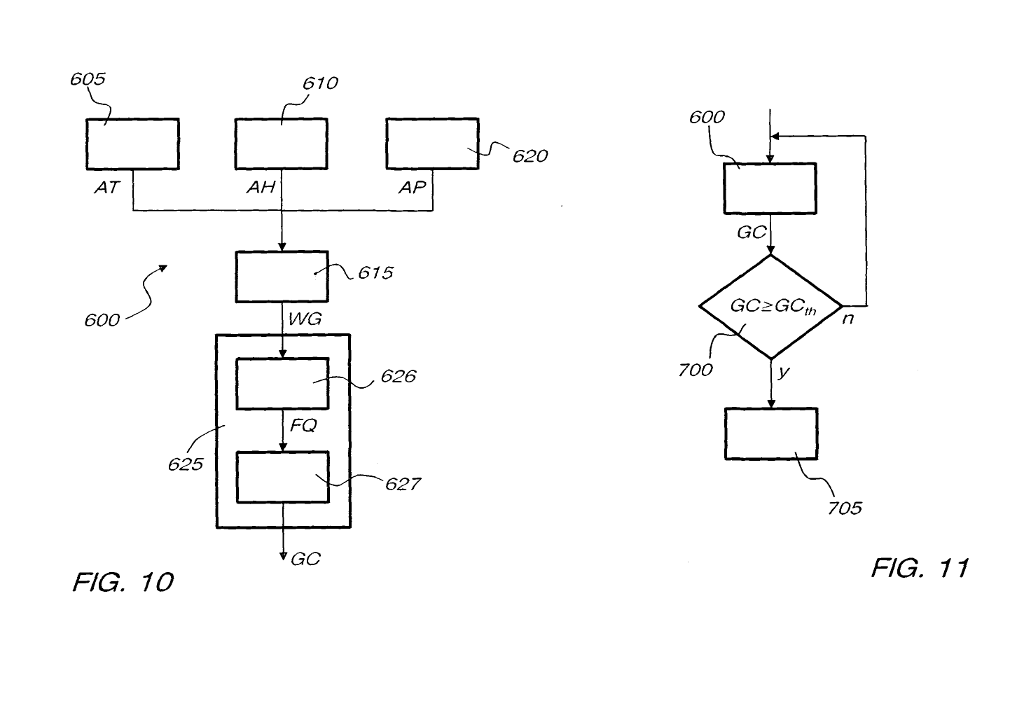

Based on the air characteristic parameters, the electronic monitor and control system 500 may be set to operate the atmospheric water generation system 20 according to an “economy mode”, which generally provides for automatically starting and stopping the water generation, in order to optimize the operation of the atmospheric water generation system 20. The “economy mode” is based on an efficiency estimation procedure 600, whose flowchart is schematically represented in FIG. 10.

The efficiency estimation procedure 600 provides for the electronic monitor and control system 500 to monitor a current value AT of the ambient air temperature (block 605) and a current value AH of the air humidity (block 610), preferably of the relative humidity. As already mentioned, these temperature and humidity values AT and AH may be directly measured with the weather station 535 or received from the remote weather forecasting center.

The monitored value AT of the air temperature and the monitored value AH of the air humidity are then used by the electronic monitor and control system 500 to estimate (block 615) a value WG of a water flow rate that can be generated by the atmospheric water generation system 20. The water flow rate is the water quantity that can be generated per unit time, for example expressed in liters per hour or liters per day. The value WG may be determined through an AT/AH/WP map that correlates each couple of air humidity and air temperature values to a correspondent estimated value WG of the water flow rate. Such map, which depends on the technical characteristics of the atmospheric water generation system 20 (e.g. air flow rate [m³/day] through the air treatment unit 40, cooling capacity [KW] of chiller unit 80, etc.), may be determined through a preliminary study and experimental activity and subsequently stored in the memory system of the electronic monitor and control system 500.

In some embodiments, the estimation of the water flow rate may take into account also a monitored value AP of the air pressure (block 620), which can be measured by means of the weather station 535 or provided by the remote weather forecasting center. For example, a number of AT/AH/WP maps may be memorized in the memory system, each of which is calibrated for a specific value (or range of values) of the air pressure. In this way, based on the monitored value AP of the air pressure, the electronic monitor and control system 500 may be configured to choose the right AT/AH/WP map to be used in the water flow rate estimation.

The estimated value WG of the water flow rate is subsequently used by the electronic monitor and control system 500 to estimate an actual value GC of an index representative of a water generation capability of the atmospheric water generation system 200 (block 625).

According to an aspect of the invention, the water generation capability index may coincide with the water flow rate itself. In this case, the estimated value GC of the index is thus simply set to be equal to the estimated value WG of the water flow rate.

According to another aspect of the invention, the water generation capability index may be the ratio of the water flow rate to a correspondent fuel rate that is consumed by the generator system 120 (e.g. by the internal combustion engine or by the hydrogen fuel cell). The fuel consumption rate is the fuel quantity which is consumed per unit time by the generator system 120, in order to generate the estimated value WG of the water flow rate. The fuel consumption rate may be expressed for example in liters of fuel per hour or per day. In this case, the electronic monitor and control system 500 is thus configured to estimate a current value FQ of the fuel consumption rate (block 626), for example on the basis of the technical characteristics of the atmospheric water generation system 20 (e.g. air flow rate [m³/day] through the air treatment unit 40, cooling capacity [KW] of chiller unit 80, etc.), taking into account the energy-efficiency of the various active devices (e.g. air blower 68, compressor 84, etc.). In some embodiments, the estimation of the fuel consumption rate value FQ may take into account also the environmental conditions, for example the air temperature value AT, the air pressure value AP and the air humidity AH. Once the fuel consumption rate value FQ has been estimated, the value GC of the water generation capability index may be calculated by the electronic monitor and control system 500 as the ratio WG/FQ (block 627) and may be expressed in terms of liters of water per liter of fuel.

While the atmospheric water generation system 20 is still inactive (see the flowchart of FIG. 11), the electronic monitor and control system 500 is configured to perform the above described efficiency estimation procedure 600 and then to compare the estimated value GC of the water generation capability index with a threshold value GCₜₕ thereof (block 700). The threshold value GCₜₕ of the water generation capability index may represent a minimum value of the generated water flow rate, below which the operational efficiency of the atmospheric water generation system 20 is considered too low.

The threshold value GCₜₕ may be determined on the basis of the actual location of the atmospheric water generation system 20. Indeed, for a given cooling capacity of the chiller unity 80, the minimum acceptable value of the water flow rate have to take into account the average weather conditions (i.e. the climate) of the region. By way of example, the minimum allowable value may be different for equatorial climates (e.g. Accra, Bandar Seri Begawan), desert climates (e.g. Luxor, Riyhad), tropical climates (Asuncion, Nairobi), Mediterranean climates (e.g. Cagliari, Cordoba) or continental climates (e.g. Moscow, Beijing). For these reasons, the threshold value GCₜₕ may be determined with a preliminary analysis of the climate of the region where atmospheric water generation system 20 is located. The analysis of the region climate may require (a minimum of) thirty years statistical elaboration of weather parameters, in order to calculate meaningful averages to be used as climate reference. Based on this climate analysis, the threshold value GCₜₕ of the water generation capability index may be determined as a preliminary activity and then stored in the memory system of the electronic monitor and control system 500.

If the estimated value GC of the index is smaller than the threshold value GCₜₕ, the electronic monitor and control system 500 does not start the water generation and repeats the efficiency estimation procedure 600 described above. In this way, the actual value GC of the water generation capability index is cyclically updated on the basis of new values of the air parameters. This control cycle may be repeated with a constant time rate, for example every 15 minutes. When the actual value GC of the index is equal or bigger than the threshold value GCₜₕ, the electronic monitor and control system 500 is configured to start the water generation (block 705). In order to start the water generation, the electronic monitor and control system 500 has to activate at least the compressor 84 of the chiller unit 80 and preferably also the air blower 68 of the air treatment unit 40. The electronic monitor and control system 500 may also activate any other device of the air treatment unit 40, chiller unit 80 or water treatment unit 100, which is involved in the water generation.

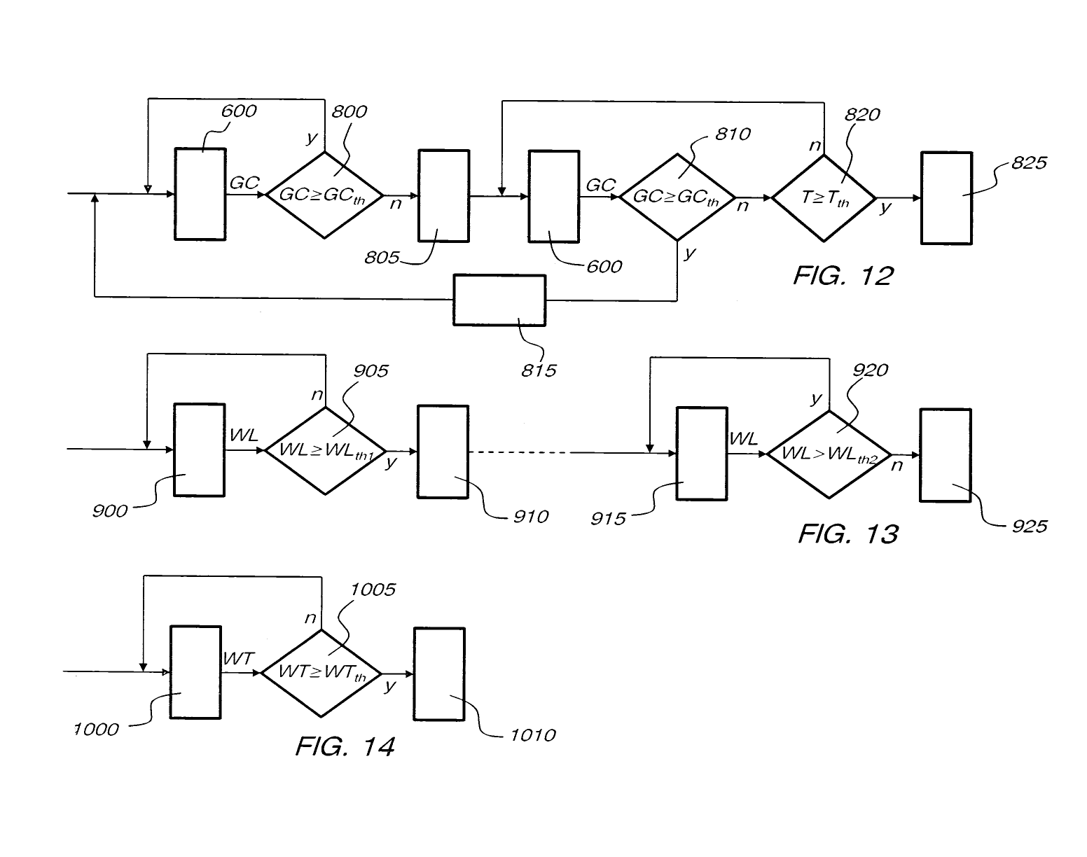

Once the water generation has been started (see flowchart of FIG. 12), the electronic monitor and control system 500 continues to perform the efficiency estimation procedure 600 and to compare the estimated value GC of the water generation capability index with the threshold value GCₜₕ (block 800). If the estimated value GC of the index is equal or bigger than the threshold value GCₜₕ, the electronic monitor and control system 500 keeps the atmospheric water generation system 20 in operation and repeats the efficiency estimation procedure 600. In this way, the water generation continues and the actual value GC of the water generation capability index is cyclically updated on the basis of new values of the air parameters. This control cycle may be repeated with a constant time rate, for example every 30 minutes.

If the actual value GC of the index becomes smaller than the threshold value GCₜₕ, the electronic monitor and control system 500 is configured to start a timer (block 805). After a predetermined time period (for example 10 minutes), the electronic monitor and control system 500 repeats the efficiency estimation procedure 600 and compares the estimated value GC of the water generation capability index with the threshold value GCₜₕ (block 810). If the estimated value GC of the index has become equal or bigger than the threshold value GCₜₕ, the electronic monitor and control system 500 resets the timer (block 815) and repeats the entire control procedure from the beginning. If conversely the estimated value GC of the index is still smaller than the threshold value GCₜₕ, the electronic monitor and control system 500 is configured to compare time value T yielded by the timer with a threshold value Tₜₕ thereof (block 820). If the timer value T is smaller than the threshold value Tₜₕ, the electronic monitor and control system 500 keeps the atmospheric water generation system 20 in operation and repeats the efficiency estimation procedure 600. This control cycle may be repeated with a constant time rate, for example after another 10 minutes. When the time value T yielded by the timer reaches or exceeds the threshold value Tₜₕ, the electronic monitor and control system 500 is configured to stop the water generation (block 825).

The global effect of this procedure is that the water generation is not stopped as soon as the actual value GC of the water generation capability index falls below the threshold value GCₜₕ, but is delayed for a predetermined time period that is represented by the threshold value Tₜₕ. By way of example, this threshold value Tₜₕ may be set to twenty minutes, so that at least two efficiency estimation procedure 600 are repeated before stopping the water generation. Thanks to this approach it's possible to prevent incidental interruptions of the water generation due to transitory changes of the ambient air conditions.

During the water generation, the electronic monitor and control system 500 may be further configured to control the water storage according to the flowchart of FIG. 13. In greater details, electronic monitor and control system 500 may be configured to monitor the water quantity in the water collecting container 65 (block 900) and to compare the monitored value WL of the water quantity with a predetermined threshold value WLₜₕ₁ thereof (block 905). The threshold value WLₜₕ₁ represents a condition where the water collecting container 65 is considered full or almost full. Hence, if the monitored value WL of the water quantity is smaller than the threshold value WLₜₕ₁, the pump 101 is kept inactive and the control cycle is repeated. If conversely the monitored value WL of the water quantity is equal or bigger than the threshold value WLₜₕ₁, the pump 101 is activated to deliver the water from the collecting container 65 into a storage tank 110 via the water treatment unit 100 (block 910).

While the pump 101 is working, the electronic monitor and control system 500 is configured to continue monitoring the water quantity in the water collecting container 65 (block 915). The monitored value WL of the water quantity is now compared with a second threshold value WLₜₕ₂ (block 920), wherein this second threshold value WLₜₕ₂ is smaller than the first threshold value WLₜₕ₁. The second threshold value WLₜₕ₂ represents a condition where the water collecting container is considered empty or almost empty. Hence, if the monitored value WL of the water quantity is bigger than the threshold value WLₜₕ₂th, the pump 101 is kept active and the control cycle is repeated. If conversely the monitored value WL of the water quantity is equal or smaller than the threshold value WLₜₕ₂, the pump 101 is stopped (block 925).

It should be observed that the procedure described in FIG. 13 may be entirely performed with the aid of a simple level sensor (not shown) located in the water collecting chamber 65 and connected to the control unit 505 through the data acquisition module 515. The level sensor may have two preset level limits, namely a high level limit and a low level limit. The pump 101 is automatically started when the level sensor reaches the high level limit and automatically stopped when it reaches the low level limit. In this way, the condensed water is periodically delivered from the water collecting container 65 to the storage tank 110, without the need of a continuous monitoring of the pump operation.

As shown in the flowchart of FIG. 14., the electronic monitor and control system 500 may be also configured to monitor a water quantity in the storage tank 110 (block 1000) and to compare the monitored value WT of this water quantity with a threshold value WTₜₕ thereof (block 1005). The threshold value WTₜₕ represents a condition where the storage tank 110 is considered full or almost full. Hence, if the monitored value WT of the water quantity is smaller than the threshold value WTₜₕ, the atmospheric water generation system 20 operates normally and the control cycle is repeated. If conversely the monitored value WT of the water quantity is equal or bigger than the threshold value WTₜₕ, the electronic monitor and control system 500 is configured to stop the water generation (block 1010).

Also this procedure may be performed with the aid of a simple level sensor (not shown) located in the storage tank 110 and connected to the control unit 505 through the data acquisition module 515. The water generation is interrupted if the level sensor exceeds a present high level limit, which means that the overall water storage capacity of the atmospheric water generation system 20 has been completely exploited.

In conclusion, it's worth highlighting that all the procedural steps involved in the control strategies described above may be performed by the electronic monitor and control system 500. That means that these procedural steps may be all performed either by the control unit 505 or by the remote administration unit 510, but it also means that these procedural steps may be partly performed by the control unit 505 and partly by the remote administration unit 510.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

What is claimed is:

1. An atmospheric water generation system (20) comprising:
a casing (22);
a water condensing heat exchanger (62) located in the casing to receive ambient air from an air inlet (42);
a chiller unit (80) located in the casing to provide the water condensing heat exchanger (62) with a chilled coolant; and
an electronic control system (500) configured to:
monitor one or more characteristic parameters of the ambient air outside and nearby the casing (22), and
start the water generation on the basis of the monitored value (AT, AH, AP) of said one or more air characteristic parameters.

2. The atmospheric water generation system (20) of claim 1, wherein the electronic control system (500) is configured to stop the water generation on the basis of the monitored value (AT, AH, AP) of said one or more characteristic parameters.

3. The atmospheric water generation system (20) of claim 1, wherein said one or more air characteristic parameters are chosen in the group consisting of: air temperature, air humidity and air pressure.

4. The atmospheric water generation system (20) of claim 1, wherein the electronic control system (500) is configured to:
use the monitored value (AT, AH, AP) of said one or more air characteristic parameters to estimate a value (GC) of an index representative of a water generation capability of the atmospheric water generation system (20), and
start the water generation, if the estimated value (GC) of the water generation capability index is above a predetermined threshold value (GCₜₕ) thereof.

5. The atmospheric water generation system (20) of claim 4, wherein the electronic control system (500) is configured to estimate the water generation capability index as a water quantity that is generated per unit time.

6. The atmospheric water generation system (20) of claim 4, wherein the electronic control system (500) is configured to:
estimate a value (WQ) of a water quantity that is generated per unit time,
estimate a value (FQ) of a fuel quantity that is consumed by an electric generator (120) per unit time to operate the atmospheric water generation system (20) during the water generation,
calculate the water generation capability index as a ratio of the water quantity value (WQ) to the fuel quantity value (FQ).

7. The atmospheric water generation system (20) of claim 4, wherein the electronic control system (500) is configured to determine the threshold value (GCₜₕ) of the water generation capability index on the basis of a geographical location of the atmospheric water generation system (20).

8. The atmospheric water generation system (20) of claim 4, wherein the electronic control system (500) is configured to stop the water generation, if the estimated value (GC) of the water generation capability index is below said threshold value (GCₜₕ).

9. The atmospheric water generation system (20) of claim 8, wherein the electronic control system (500) is configured to stop the water generation, if the estimated value (GC) of the water generation capability index remains below said threshold value (GCₜₕ) for a predetermined time period (Tₜₕ).

10. The atmospheric water generation system (20) of claim 1, wherein the electronic control system (500) is configured to measure the values (AT, AH, AP) of said one or more air characteristic parameters through one or more sensors (535).

11. The atmospheric water generation system (20) of claim 1, wherein the electronic control system (500) is configured to receive the values (AT, AH, AP) of said one or more air characteristic parameters from a weather forecasting center.

12. The atmospheric water generation system (20) of claim 1, wherein the electronic control system (500) comprise a control unit (505) configured to send data and receive commands to/from a remote administration unit (510).

13. The atmospheric water generation system (20) of claim 12, wherein the control unit (505) is connected to the remote administration unit (510) by means of a remote data transmission system (525).

14. The atmospheric water generation system (20) of claim 13, wherein the remote data transmission system (525) is based on internet.

15. The atmospheric water generation system of claim 1, wherein the electronic control system (500) is configured to:
monitor a water quantity in a water collecting container (65) provided for receiving water from the water condensing heat exchanger (62),
activate a pump (101) to deliver the water from the collecting container (65) into a storage tank (110), if the monitored value (WL) of the water quantity in the collecting container (65) is above a predetermined threshold value (WLₜₕ₁) thereof.

16. The atmospheric water generation system (20) of claim 15, wherein the electronic control system (500) is configured to deactivate the pump (101), if the monitored value (WL) of the water quantity in the collecting container (65) is below a predetermined second threshold value (WLₜₕ₂) thereof, wherein the second threshold value (WLₜₕ₂) is smaller than the first threshold value (WLₜₕ₁).

17. The atmospheric water generation system (20) of claim 16, wherein the electronic control system (500) is configured to:
monitor a water quantity in the storage tank (110),
stop the water generation, if the monitored value (WT) of the water quantity in the storage tank (110) is above a predetermined threshold value (WTₜₕ) thereof.

18. A method of operating an atmospheric water generation system (20),
wherein the atmospheric water generation system (20) comprises:
a casing (22);
a water condensing heat exchanger (62) located in the casing to receive ambient air from an air inlet (42); and
a chiller unit (80) located in the casing to provide the water condensing heat exchanger (62) with a chilled coolant; and
wherein the operating method comprises the steps of:
monitoring one or more characteristic parameters of the ambient air outside and nearby the casing (22), and
starting the water generation on the basis of the monitored value (AT, AH, AP) of said one or more air characteristic parameters.

19. The method of claim 18, comprising the step of stopping the water generation on the basis of the monitored value (AT, AH, AP) of said one or more air characteristic parameters.

20. The method of claim 18, wherein said one or more air characteristic parameters are chosen in the group consisting of: air temperature, air humidity and air pressure.

21. The method of claim 18, comprising the steps of:
using the monitored value (AT, AH, AP) of said one or more air characteristic parameters to estimate an index representative of a water generation capability of the atmospheric water generation system (20), and
starting the water generation, if the estimated value (GC) of the water generation capability index is above a predetermined threshold value (GCₜₕ) thereof.

22. The method of claim 21, wherein the water generation capability index is estimated as a water quantity that is generated per unit time.

23. The method of claim 21, comprising the steps of:
estimating a value (WQ) of a water quantity that is generated per unit time,
estimating a value (FQ) of a fuel quantity that is consumed by an electric generator (120) per unit time to operate the atmospheric water generation system (20) during the water generation,
calculating the water generation capability index as a ratio of the water quantity value (WQ) and the fuel quantity value (FQ).

24. The method of claim 21, wherein the threshold value (GCₜₕ) of the water generation capability index is determined on the basis of a geographical location of the atmospheric water generation system (20).

25. The method of claim 21, comprising the step of stopping the water generation, if the estimated value (GC) of the water generation capability index is below said threshold value (GCₜₕ).

26. The method of claim 25, comprising the step of stopping the water generation, if the estimated value (GC) of the water generation capability index remains below said threshold value (GCₜₕ) for a predetermined time period (Tₜₕ).

27. The method of claim 18, wherein the values (AT, AH, AP) said one or more air characteristic parameters are measured through one or more sensors (535).

28. The method of claim 18, wherein the values (AT, AH, AP) of said one or more air characteristic parameters are received from a weather forecasting center.

29. The method of claim 18, comprising the steps of sending data from a control unit (505) to a remote administration unit (510) and of receiving commands from remote administration unit (510) to the control unit (505).

30. The method of claim 29, wherein the control unit (505) is connected to the remote administration unit (510) by means of a remote data transmission system (525).

31. The method of claim 30, wherein the remote data transmission system (525) is based on internet.

32. The method of claim 18, comprising the steps of:
monitoring a water quantity in a water collecting container (65) provided for receiving water from the water condensing heat exchanger (62),
activating a pump (101) to deliver the water from the collecting container (65) into a storage tank (110), if the monitored value (WL) of the water quantity in the collecting container (65) is above a predetermined threshold value (WLₜₕ₁) thereof.

33. The method of claim 32, comprising the steps of deactivating the pump (101), if the monitored value (WL) of the water quantity in the collecting container (65) is below a predetermined second threshold value (WLₜₕ₂) thereof, wherein the second threshold value (VVLₜₕ₂) is smaller than the first threshold value (WLₜₕ₁).

34. The method of claim 33, comprising the steps of:
monitoring a water quantity in the storage tank (110),
stop the water generation, if the monitored value (WT) of the water quantity in the storage tank (110) is above a predetermined threshold value (WTₜₕ) thereof.
